(19) United States
(12) Patent Application Publication
(10) Pub. No.: US 2013/0194609 A1
(43) Pub. Date: Aug. 1, 2013

(54) PRINTING APPARATUS AND METHOD OF CONTROLLING THE SAME

(71) Applicant: CANON KABUSHIKI KAISHA, Tokyo (JP)

(72) Inventor: Yasutomo Tanaka, Kawasaki-shi (JP)

(73) Assignee: CANON KABUSHIKI KAISHA, Tokyo (JP)

(21) Appl. No.: 13/742,995

(22) Filed: Jan. 16, 2013

(30) Foreign Application Priority Data
Jan. 31, 2012 (JP) 2012-018633

(51) Int. Cl. G06K 15/00

(52) U.S. Cl. CPC G06K 15/4095
USPC 358/1.14

(57) ABSTRACT

A printing apparatus, and a control method thereof, stores received print data into a first memory and prints the print data stored in the first memory. The printing apparatus and method, in a case where the print data is job data for which authentication is necessary before printing, store the print data stored in the first memory into a second memory and, and delete the print data stored in the first memory after the print data has been printed, and in a case where the print data is not job data for which authentication is necessary before printing, retain the print data stored in the first memory even after the printing.

### BACKGROUND OF THE INVENTION

1. Field of the Invention

The present invention relates to a printing apparatus, and a method of controlling thereof, that prints once again in accordance with an instruction to print once again caused by a panel operation by a user.

2. Description of the Related Art

After printing a document by a printing apparatus, a request may be made from a user to once again print the same document with the printing apparatus. There exists a technique (see, for example, Japanese Patent Laid-open No. 2001-63158) for, in response to this request, printing again a specified document when an instruction to print once again (hereinafter referred to as “reprint”) is input using an operation panel, without resending print data from a host computer to the printing apparatus.

In normal printing processing, a printing apparatus temporarily saves, as necessary, print job data, received from a host computer, to secondary storage device of the printing apparatus, and deletes the saved print job data after the printing processing for the print job completes. However, in a reprint mode, the printing apparatus does not delete the saved print job data, and keeps the data saved until the secondary storage device runs out of space. Because of this, a user can once again print an image that has been printed, without resending print data from a host computer, with a reprint instruction from the operation panel of the printing apparatus.

Meanwhile, in recent years, there are types of printing apparatuses that support a secure print function. “Secure print” is a function in which, when sending a print job from a host computer to a printing apparatus, a password is attached to the print job and the print job is sent, and after that, when a user enters a password from an operation panel of the printing apparatus, and the password matches the password of the print job, printing is carried out according to that print job. This is a function that is useful in the case where a document with a high degree of confidentiality is to be printed.

On a printing apparatus that has implemented a reprint function, even after the print completes, the print job data is not deleted; it is kept saved until the secondary storage device runs out of space. Generally, such things a hard discs (HDD) and SD cards are used for the secondary storage device on which the print job data is saved. Particularly in recent years, SD cards, which have the merits of miniaturization and resistance to vibration, have been widely used. However, because these SD cards are easy to remove, and a third party can remove the SD card and browse the data saved thereon, there exists a security problem. In particular, saving print job data for which security is emphasized, such as print data for which secure print is specified, for long periods of time on this kind of removable SD card is undesirable. For this reason, print job data for which secure print is specified cannot be made the target of a reprint, and the convenience of the user has suffered.

### SUMMARY OF THE INVENTION

An aspect of the present invention is to eliminate the above-mentioned problems which are found in the conventional technology.

A feature of the present invention is to provide a technique for reducing the security risk for secure print job data in reprint mode.

According to an aspect of the present invention, there is provided a printing apparatus, to which a first memory removably connects, the printing apparatus comprising: a receiving unit configured to receive print data; a controller configured to store in the first memory the print data received by the receiving unit; and a printer configured to print the print data stored in the first memory; wherein the controller stores the print data stored in the first memory in a second memory and, after the printer has printed the print data stored in the first memory, deletes the print data stored in the first memory, in a case where the print data received by the receiving unit is job data for which authentication is necessary before printing, and wherein the controller retains the print data stored in the first memory even after the printing, in a case where the print data received by the receiving unit is not job data for which authentication is necessary before printing.

According to another aspect of the present invention, there is provided a method for controlling a printing apparatus, to which a first memory removably connects, the method comprising: a receiving step of receiving print data; a step of storing in the first memory the received print data; a printing step of printing the print data stored in the first memory; a step of storing the print data stored in the first memory in a second memory and, after the print data stored in the first memory is printed in the printing step, deleting the print data stored in the first memory, in a case where the print data received in the receiving step is job data for which authentication is necessary before printing, and a step of retaining the print data stored in the first memory even after the printing, in a case where the print data received by the receiving unit is not job data for which authentication is necessary before printing.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating an outline of a printing system including an image-forming device according to an embodiment of the present invention.

FIG. 2 is a block diagram illustrating an example configuration of a controller.

FIG. 3 is a diagram explaining the flow of data in the controller of a printer according to the embodiment.

FIG. 4 is a diagram illustrating an example of a management table of saved jobs managed by a saved job controller according to the embodiment.

FIGS. 5A-5D depict views illustrating examples of user interface screens for receiving the reprint instruction displayed on an operation panel of the printer according to the embodiment.

FIG. 6 is a flowchart for describing printing processing in a normal mode of the printer according to the embodiment.

FIG. 7 is a flowchart for describing printing processing in a reprint mode of the printer according to the embodiment.

FIG. 8 is a flowchart for describing job spool area allocation processing when in the reprint mode of step S702 in FIG. 7.

FIG. 9 is a flowchart for describing execution processing for a secure print job in the reprint mode of the printer according to the embodiment.

FIG. 10 is a flowchart for describing processing for allocating a job spool area 502 in the case where a secure print job was received in the reprint mode, in step S902 of FIG. 9.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

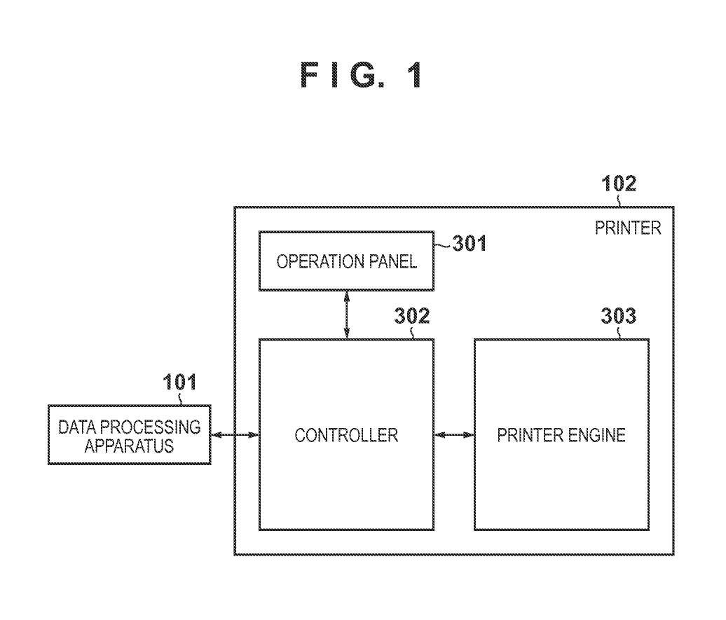

FIG. 1 is a block diagram illustrating an outline of a printing system including an image-forming device (printing apparatus) according to an embodiment of the present invention.

In the figure, a data processing apparatus 101 is, for example, a host computer, and functions as a source of print data. In this embodiment, a laser beam printer (hereinafter referred to as “printer”) is used as an image forming apparatus 102. The image forming apparatus applied to this embodiment is not limited to a laser beam printer, and a printer of another printing method such as an inkjet printer can be used.

A printer controller (controller) 302 generates raster data for each page based on print data (for example, page description language (hereinafter referred to as “PDL”)) supplied from the data processing apparatus 101 and sends the raster data to a printer engine 303. The printer engine forms a latent image on a photoconductive drum based on raster data that is supplied from the controller 302, and by transferring/fixing the latent image onto a recording image (xerographic method), prints (forms) an image.

An operation panel 301 is used as a user interface. The controller 302 receives user's intended operation instructions via the operation panel 301. Also, the controller 302 displays such things as processing details of the printer 102 and warnings to the user via the operation panel 301.

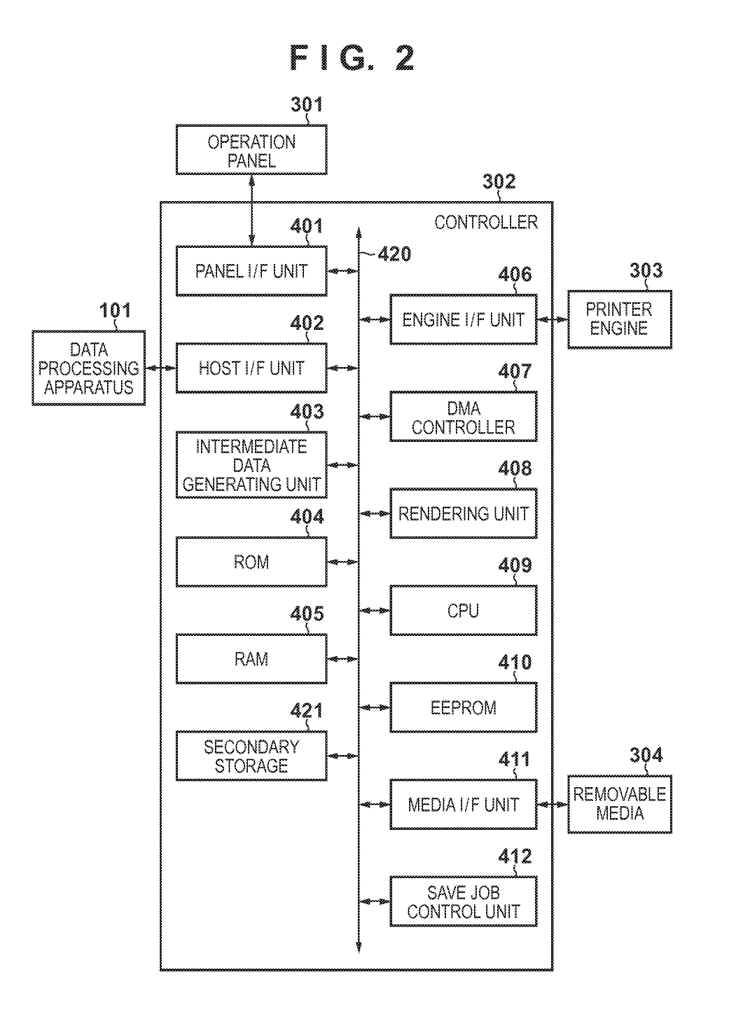

FIG. 2 is a block diagram illustrating an example configuration of a controller 302.

In the figure, a panel interface unit 401 carries out data communication between the operation panel 301 and the controller 302. A CPU 409 receives user settings and instructions from the operation panel 301 via the panel interface unit 401. A host interface unit 402 provides a bidirectional communication connection with the data processing apparatus 101 (a host computer or the like) via a network or USB. An intermediate data generating unit 403 converts print jobs, received from the data processing apparatus 101 via the host interface unit 402, into intermediate data in a form that is easy to handle inside of the printer 102. A ROM 404 holds program code for the processing according to the embodiment, other control carried out by the printer 102 and the like. In the ROM 404 there is a NOR-type Flash ROM that is used for booting and there is a NAND-type Flash ROM (second storage element) that is used as a storage area for programs and as a job spool area and so on, and these are implemented on the circuit board of the controller 302. A RAM 405 provides a work area during the processing of the CPU 409, and it is used to store each kind of data. Included within the types of data that the CPU 409 stores in the RAM 405 is print data received via the host interface unit 402, intermediate data that the print data is interpreted to generate, and bitmap data that the intermediate data is rendered to generate. Furthermore, also included in the types of data that the CPU 409 stores in the RAM 405, are such things as various types of temporary statuses necessary for other processing.

A secondary storage (first storage element) 421 saves print data received via the host interface unit 402, log information and the like. An HDD, an SD card or the like may be used for the secondary storage 421. An engine interface unit 406 controls the interface with the printer engine 303. The CPU 409 recognizes the state of the printer engine 303 via the engine interface unit 406. A DMA controller 407 controls DMA transfer between the engine interface unit 406 and the RAM 405, or between the RAM 405 and the secondary storage 421. The CPU 409 can transfer bitmap data stored in the RAM 405 to the engine interface unit 406 via the DMA controller 407. A rendering unit 408, according to the contents of intermediate data stored in the RAM 405, extracts a bitmap image. The extracted bitmap image data is stored in the RAM 405. A CPU 409 controls each device connected to a CPU bus 420 based on control program code stored in the ROM 404. An EEPROM 410 is a non-volatile memory for holding setting information of the printer 102. A media interface unit 411 reads and writes various types of data, such as image data, program data and device setting data from a removable memory 304 (USB memory etcetera). A saved job controller 412 is a module of a program that is saved in the ROM 404 of the controller 302, and executed by the CPU 409. The saved job controller 412 manages the saving and deleting, according to the instruction of the CPU 409, such things as print job data received from the data processing apparatus 101 and attribute information. The saved job controller 412 is one of the important components in realizing the reprint function. The CPU bus 420 is a bus that includes address, data and control buses and each of the above described devices from 401 to 410 can access all of the devices connected to the CPU bus 420.

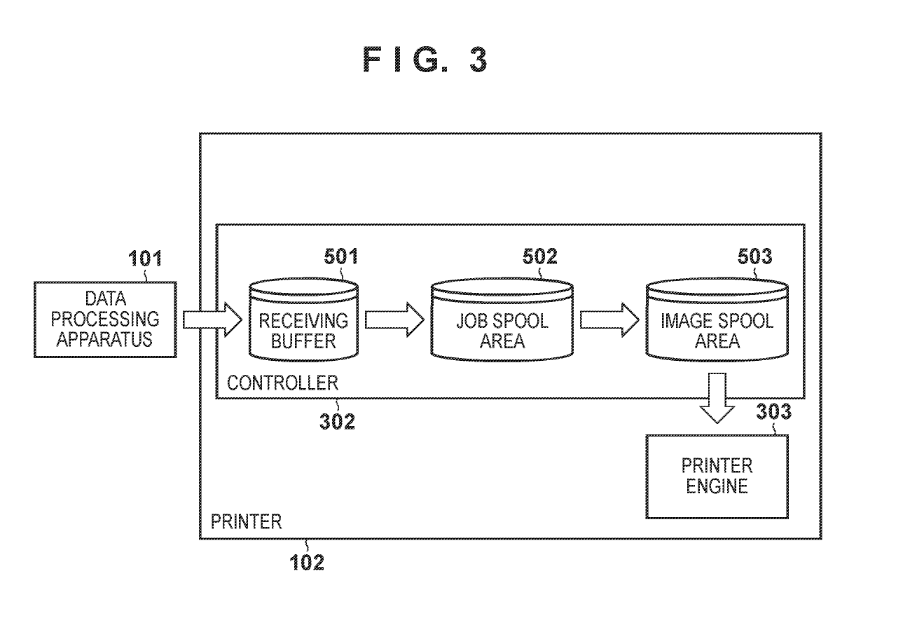

FIG. 3 is a diagram explaining the flow of data in the controller 302 of the printer 102 according to the embodiment.

A receiving buffer 501 is allocated in the RAM 405. A job spool area 502 is allocated in the secondary storage 421. The receiving buffer 501 normally takes up less space than the job spool area 502. An image spool area 503 is allocated in the RAM 405. Data flow in the controller 302 with be explained below referring to the configurations of FIG. 2 and FIG. 3.

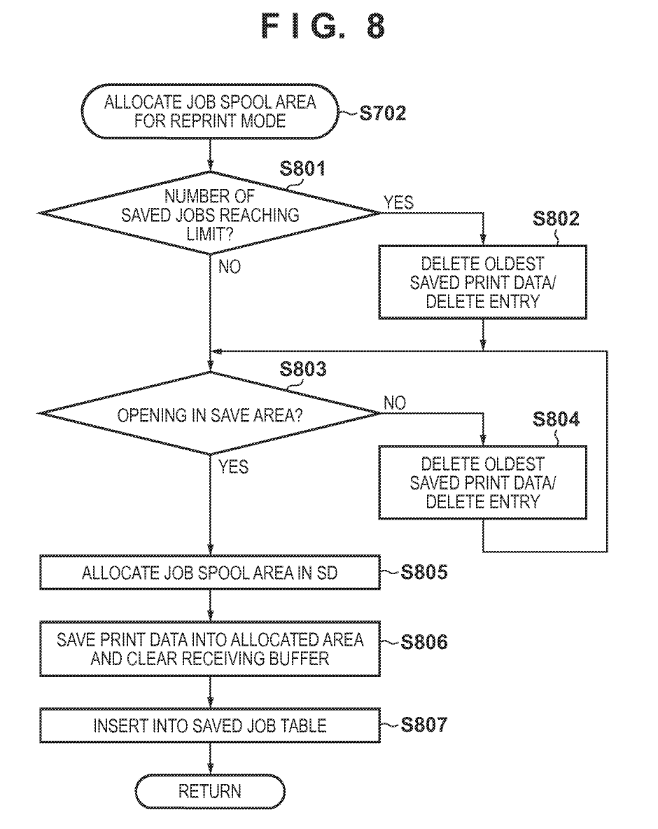

The host interface unit 402 receives print data from the data processing apparatus 101 and saves it in the receiving buffer 501 if the receiving buffer 501 has space. The saved job control unit 412 checks whether there is available space greater or equal in size to that of the receiving buffer 501 in the job spool area 502 when the saved job control unit 412 receives a notice that print data was saved in the receiving buffer 501. The saved job control unit 412 waits until there is an opening when there is no opening. When there is an opening, the saved job control unit 412 saves the print data as a print job in the job spool area 502 and deletes the data in the receiving buffer, thereby emptying the receiving buffer 501. In FIG. 8, as explained later, the saved job control unit 412 performs asynchronously the processing of deleting the saved job that is saved in the job spool area 502.

The intermediate data generating unit 403 reads out print job data that is saved in the job spool area 502 based on the condition that there is available space of a predetermined size in the image spool area 503, and performs PDL interpretation processing (intermediate data generation processing) thereupon. Data generated by the intermediate data generating unit 403 is saved in a buffer logically allocated in the RAM 405. The rendering unit 408 starts rendering processing according to the intermediate data stored in the buffer, and saves the bitmap image generated through this rendering processing into the image spool area 503. The engine interface unit 406 transfers the bitmap image in the image spool area 503 to the printer engine 303 via the DMA controller while synchronizing with the printer engine 303.

The reprint mode will be explained below referring to FIGS. 1 through 3.

The controller 302, according to this embodiment, has, in addition to a normal mode in which print data is received from the data processing apparatus 101 and printed, a reprint mode, and it is possible to toggle between the reprint operation mode and the normal mode via settings on a user menu on the main body of the printer.

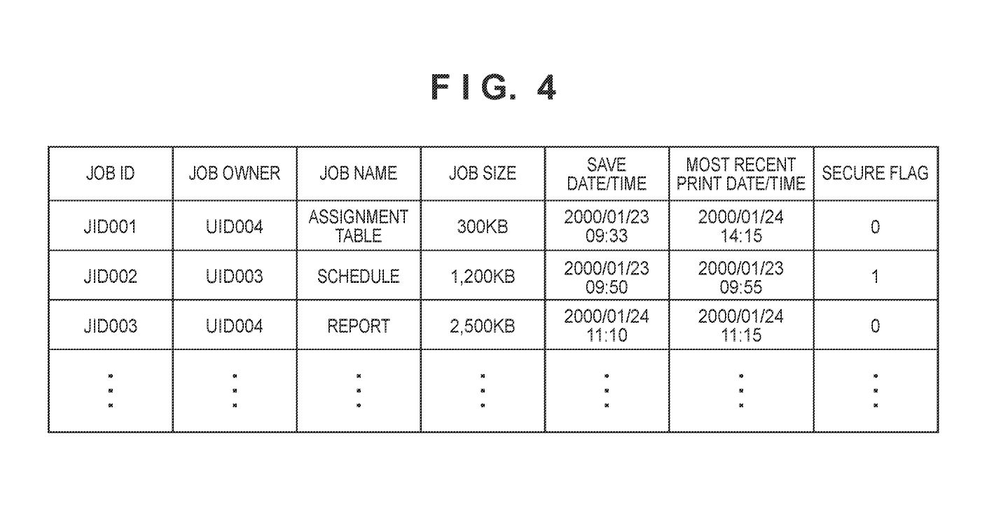

The reprint mode is a mode in which, print job data is saved into the job spool area 502 upon a printing, and at another time, following a print instruction from a user, the saved print job data is printed once again. When the reprint mode is set, the controller 302 controls via the saved job control unit 412 so that even though the print job has finished, job data, that is automatically saved in a job spool area 502, is not deleted but instead left. When the reprint mode is set, the saved job control unit 412 manages saved jobs according to a saved job management table explained later while referring to FIG. 4.

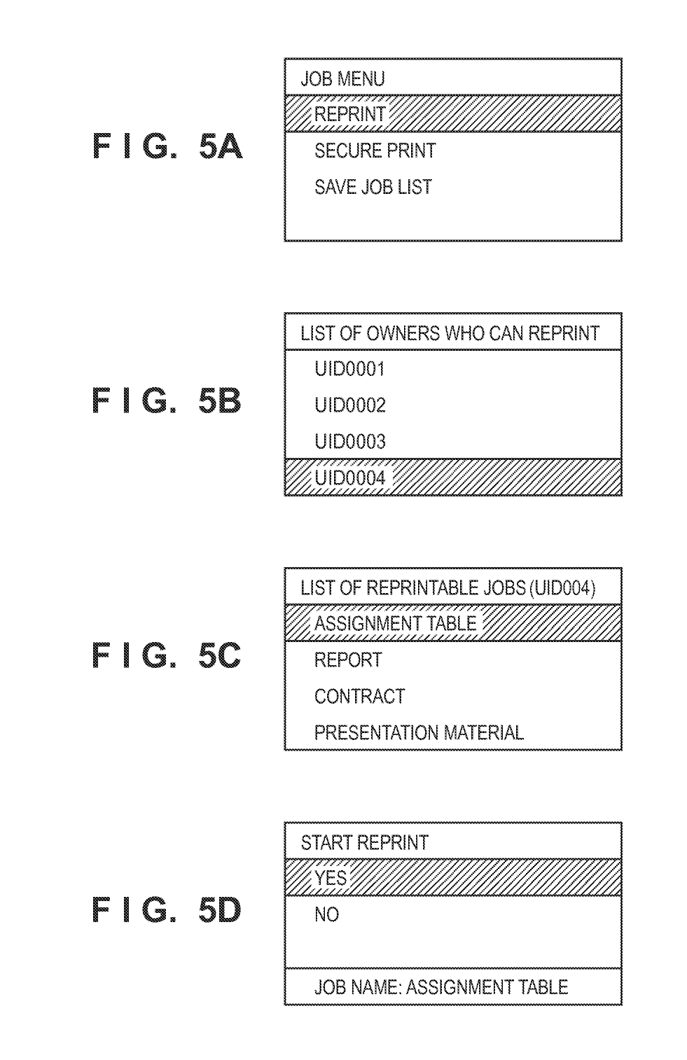

The controller 302 displays print jobs that are saved in the job spool area 502 via a panel interface unit 401 in a list of jobs that can be reprinted. The display screen of the operation panel 301 upon which the list of jobs that can be reprinted is displayed is explained later while referring to FIGS. 5A-5D. If there is a reprint instruction from a user via the operation panel 301 related to the list of jobs that can be reprinted that is displayed on the operation panel 301, the controller 302 prints the saved job that is the target of an instruction.

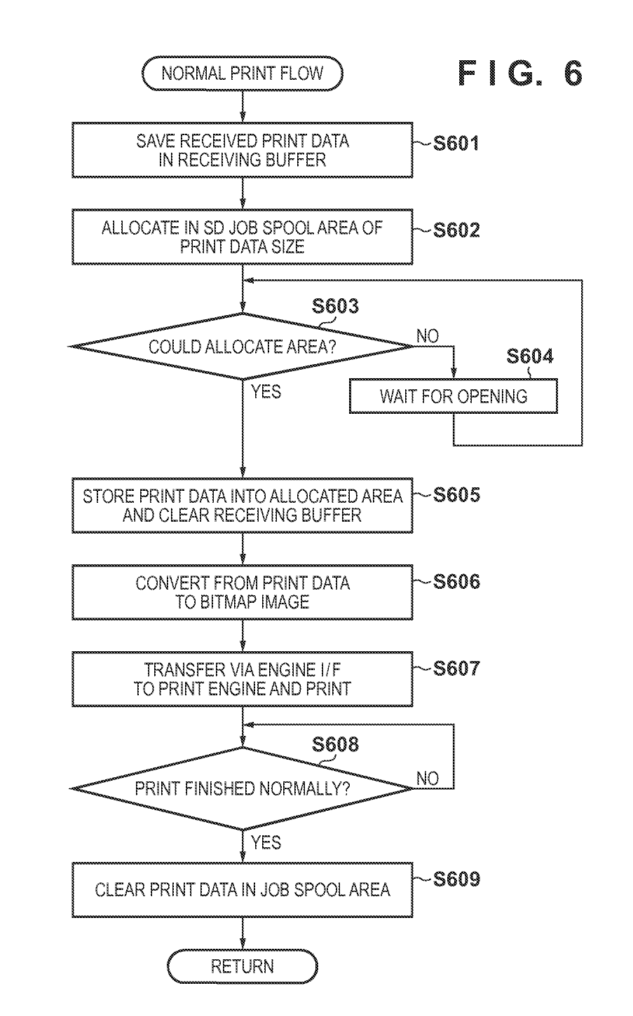

When the reprint mode is set, the controller 302 changes the processing flow of print data from that when the normal mode is set. Furthermore, in the case where the reprint mode is set, the controller 302 also changes the processing flow of print data for times a normal print jobs is executed and for times when a secure print job is executed. The detailed flow for these is explained later referring to FIGS. 6 through 9.

FIG. 4 is a diagram illustrating an example of a management table of saved jobs managed by a saved job controller 412 according to the embodiment.

The table in FIG. 4 illustrates an example of a saved job management table for managing all of the jobs that the saved job control unit 412 saved in the job pool area 502. The saved job management table is saved in a management area of the job spool area 502.

The saved job control unit 412 determines whether or not transfer data is new job data, when saved job control unit 412 transfers the print data saved in the receiving buffer 501 to the job spool area 502. When the saved job control unit 412 determines that the transfer data is a new job, the saved job control unit 412 interprets the job information part of the print data, extracts information (the job ID, the job owner, the job name, the job size and the secure flag), and inserts the information into the saved job management table. At the same time, the saved job control unit 412 inserts the date/time at which the new job is saved as the save date/time of the target job. Furthermore, the saved job control unit 412 inserts or updates the most recent print date/time of the target job, according to a print end notification from the engine interface unit 406.

FIGS. 5A-5D depict views illustrating examples of user interface screens for receiving the reprint instruction displayed on an operation panel 301 of the printer 102 according to the embodiment.

FIG. 5A is the job menu screen for operating jobs saved in the job spool area 502. With this job menu screen, via the operation panel 301, a user selects “reprint” (selected with a cursor). As a result of this, the panel interface unit 401 displays, via the saved job control unit 412, a screen as shown in FIG. 5B according to the job owner information in the saved job management table (FIG. 4).

FIG. 5B illustrates an example of a display of a list of owners who can reprint, and on this screen reprint instruction job owner information is input. For example, on this screen, via the operation panel, the user selects “UID0004” using the cursor. As a result of this, the panel interface unit 401 displays, via the saved job control unit 412, a screen as shown in FIG. 5C according to the job name corresponding to job owner “UID0004”.

FIG. 5C is a screen that displays a list of jobs where the job owner is “UID0004” and that can be reprinted, and from this screen, job information of the target of the reprint is entered. For example, on this screen, via the operation panel 301, the user selects “assignment table”. As a result of this, the panel interface unit 401, via the saved job control unit 412, obtains the job ID (JID001: FIG. 4) corresponding to the job name “assignment table”, and displays a screen as shown in FIG. 5D.

FIG. 5D is a screen on which the commencement of the reprint is confirmed. For example, on this screen, via the operation panel 301, when the user selects “YES”, the panel interface unit 401 instructs the saved job control unit 412 to start a reprint for job ID “JID001”. The saved job control unit 412 generates a reprint job according to the instruction to start the reprint for job ID “JID001” from the panel interface unit 401.

FIG. 6 is a flowchart for describing printing processing in a normal mode of the printer 102 according to the embodiment. This processing is realized by execution by the CPU 409 of a program stored in the ROM 404.

First, in step S601, the print data that was received from the data processing apparatus 101 is saved in the receiving buffer 501 that is allocated in a part of the RAM 405. Next, the processing proceeds to step S602, all of the print data is stored in the receiving buffer 501, and in a part of the secondary storage 421 a job spool area 502 is allocated such that the size is just enough to be able to store the amount of print data that was received. In step S603, it is determined whether it was possible to allocate the job spool area 502, and in the case where allocation could not be made (the case where there was not enough space), the processing proceeds to step S604, and until space opens up a wait is performed. When it is determined that the allocation of the job spool area 502 could be made, the processing proceeds to step S605, the print data of the receiving buffer 501 is transferred to the job spool area 502, and to prepare for the receipt of subsequent print data, the receiving buffer 501 is cleared. Next, the processing proceeds to step S606, and the CPU 409 changes the print data into a data format in which the data is transferred to engine interface unit 406 (expressed as a bitmap image in this embodiment). The data, after being converted in this way, is once again stored in the secondary storage 421. Next, the processing proceeds to step S607, and while synchronizing with the printer engine 303, the converted data is transferred to the printer engine 303 via the engine interface 406. The printer engine 303, having received this data, carries out printing according to the data. In step S608, when the printing finishes normally, the processing proceeds to step S609, the print data stored in the job spool area 502 of the secondary storage 412 is deleted, and the printing processing finishes.

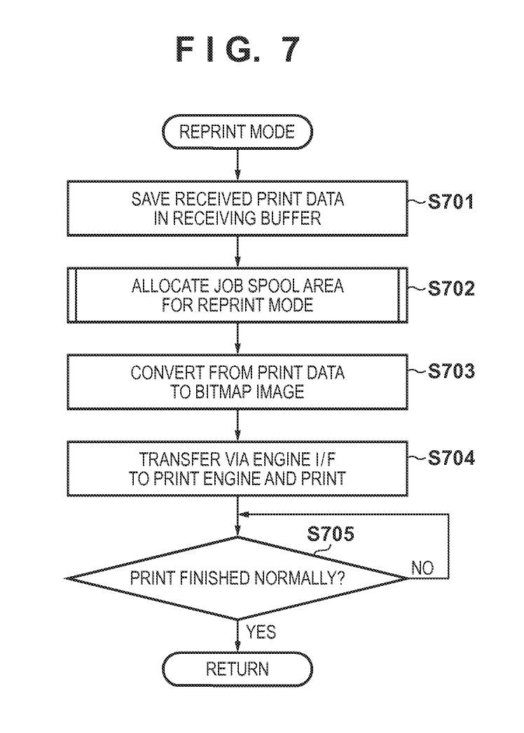

FIG. 7 is a flowchart for describing printing processing in the reprint mode of the printer 102 according to the embodiment. This processing is realized by execution by the CPU 409 of a program stored in the ROM 404.

Here, firstly, in step S701, in the same way as in the normal printing processing explained in FIG. 6, the received print data is saved in the receiving buffer 501 that is allocated in the RAM 405 or the like. Next the processing proceeds to step S702, and in order to save the print data for the reprint, the job spool area 502 for when in the reprint mode is allocated. In the case of the reprint mode, the received print data is maintained in the job spool area 502 even after the completion of the printing, and printing is once again carried out in response to an instruction from a user. Accordingly, it is necessary for the saved job control unit 412 to manage the print data stored in the job spool area 502. In this embodiment, the saved job management table of FIG. 4 is created and stored in the RAM 405 or in secondary storage 421, and the management of the print data and the attributes thereof is carried out.

The processing illustrated by steps S703 through S705 is the same as the processing in steps S606 through S608 in FIG. 6 previously described.

FIG. 8 is a flowchart for describing job spool area allocation processing when in the reprint mode of step S702 in FIG. 7.

Firstly, in step S801, it is determined whether the number of jobs currently saved for the reprint has reached a predetermined limit. Here, the determination is made including the print data that was received this time in the number of jobs. In step S801, in the case where it was determined that the number of jobs has reached the limit, the processing proceeds to step S802, and out of the print data that was previously saved, the print data that was saved the longest time ago is identified referring to the saved job management table. The identified print data is deleted, the corresponding entry is deleted from the saved job management table, and the processing proceeds to step S803. On the other hand, in step S801, if it is determined that the number of jobs has not reached the limit, the processing proceeds to step S803.

In step S803, it is determined whether it is possible to allocate in the save area the space needed for the print data received this time. In the case where there is not enough space in the save area, the processing proceed to step S804 and as in step S802, out of the print data that was previously saved, oldest data is deleted, the corresponding print job entry is deleted from the saved job management table, and the processing proceeds to step S803. It is necessary to repeat step S804 until it is possible to allocate a space in the save area. When the save area can be allocated, the processing proceeds to step S805 and a job spool area 502 that is greater than or equal to the size of the received print data is allocated. Next, the processing proceeds to step S806, the print data is transferred from the receiving buffer 501 to the job spool area 502, and when the transfer completes, the receiving buffer 501 is cleared. Next, the processing proceeds to step S807, and as the final part of the job spool area 502 allocation processing, the attribute information for the print job saved this time is entered into the saved job management table.

Here, the processes once again returns to FIG. 7, and when the job spool area allocation processing for the reprint of step S702 finishes, after that printing is carried out according to the print data, as explained in steps S606 through S608 in FIG. 6 (steps S703 through S705). However, the point that differs from the normal printing processing explained in FIG. 6 is that the print data saved in the job spool area 502 is not deleted even when the print finishes. This is because the print data will be reused when the reprint is performed.

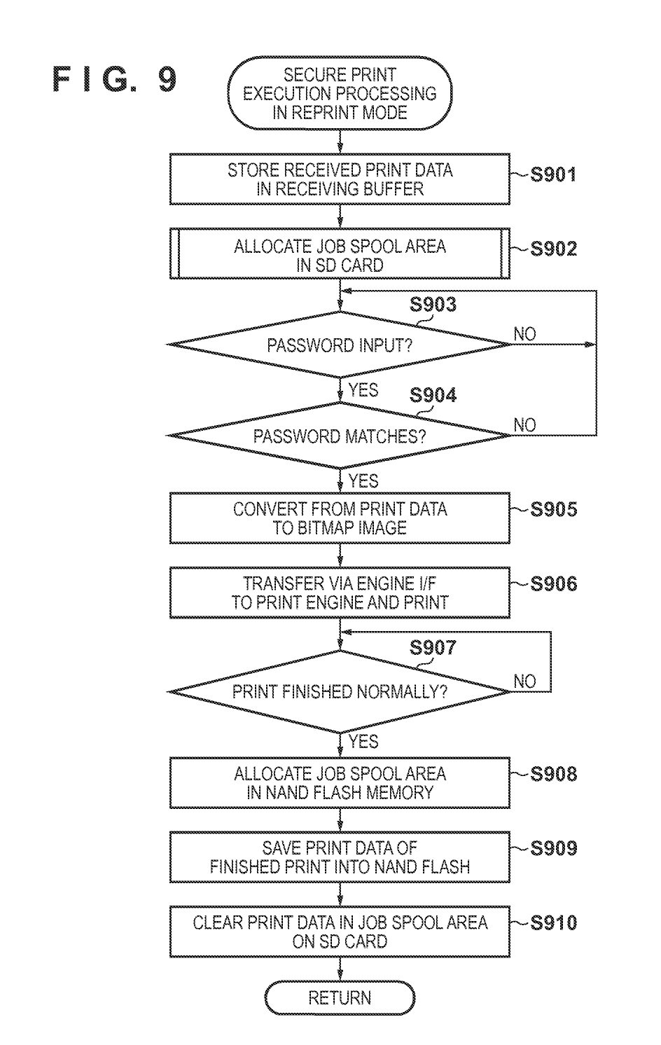

FIG. 9 is a flowchart for describing execution processing for a secure print job in the reprint mode of the printer 102 according to the embodiment. This processing is realized by execution by the CPU 409 of a program stored in the ROM 404.

Here, in the same way as in the print flow of the reprint mode described in FIG. 7, firstly in step S901, the print data received from the data processing apparatus 101 is stored in the receiving buffer 501. Next, the processing proceeds to step S902, and processing specific to the secure print, for the allocation of the job spool area 502 for the reprint, is carried out. This management processing is described below in detail.

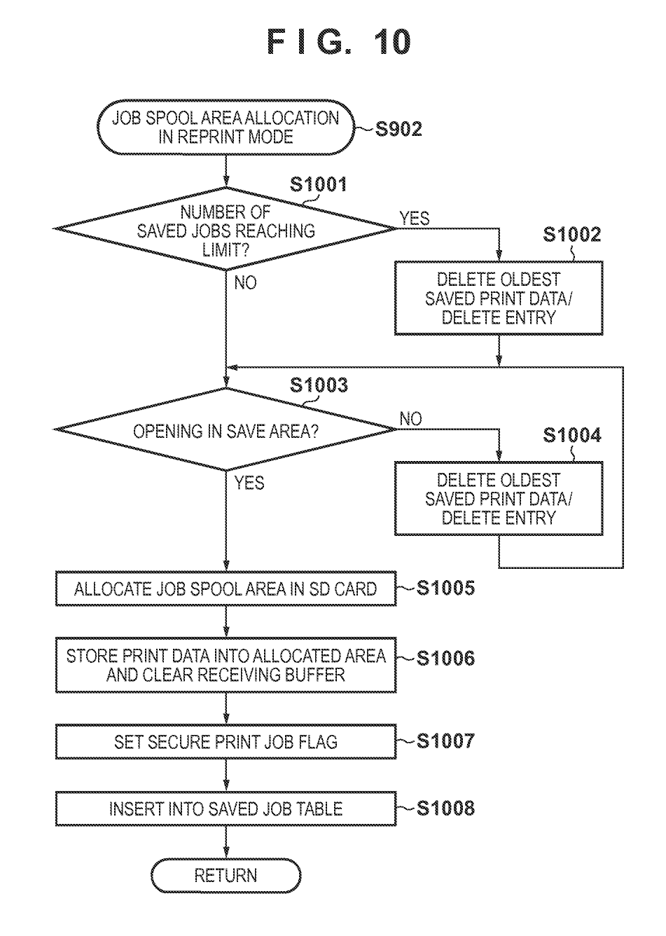

FIG. 10 is a flowchart for describing processing for allocating a job spool area 502 in the case where a secure print job was received in the reprint mode, in step S902 of FIG. 9.

As explained in steps S801 through S804 in FIG. 8, in steps S1001 through S1004, the conditions regarding such things as the saved job number limit and the save area limit are determined, and if necessary, processing for deleting print data is carried out.

When an open space can be allocated, the processing proceeds to step S1005, and a job spool area 502 of a size equal to or larger than that of the received print data is allocated. Next the processing proceeds to step S1006, the print data is transferred from the receiving buffer 501 to the job spool area 502, and when completely transferred, the receiving buffer 501 is cleared. Here, processing specific to secure print is carried out. Specifically, in step S1007, a flag, indicating that the job is a secure print job, is set, and in step S1008, when inserting into the saved job management table, a flag, showing that the job is a secure print job, is raised. Refer to the secure flag for job ID “JID002” in FIG. 4. Because of this flag, when referring to the saved job management table, it is possible to distinguish whether or not a print job is a secure print job.

Returning once again to the print flow in secure print mode of FIG. 9, in step S902, after storing the print data in the job spool area 502, before proceeding to the printing processing, in step S903 it is determined whether a password has been entered from the operation panel 103. As previously described, in a secure print, when an instruction to print from the data processing apparatus 101 is made, a password is preset in a printer driver. The password set here is sent to the printer 102 along with the print job. Then when a user enters a password from the operation panel 103 of the printer 102 and the passwords match, the printing of the corresponding print job is executed. Accordingly, in step 904, in the case where a password is entered from the operation panel 103, it is determined whether or not the password that was entered matches with a password that was set for a print job. If the password does not match, the processing returns to step S903. In the case where the password does match, the processing proceeds to step S905. In steps S905 through S907, the same kind of processing is carried out as that explained in steps S606 through S608 of FIG. 6.

In step S907, when it is determined that the printing has finished normally, the processing proceeds to step S908. In step S908, the clearing of the print data is not carried out. A job spool area is allocated in a storage device (for example, NAND Flash ROM) that is implemented on the circuit board of the controller 302 and is non-removable. At this point, if necessary, in the same way as the processing illustrated in step S801 through S804 of FIG. 8, processing to allocate an open space in that storage device is carried out, and an open space in the NAND Flash ROM is created in order to allocate the job spool area. Next, the processing proceeds to step S909, and print data for which printing has completed is transferred from an SD card to the job spool area that was allocated in the NAND Flash ROM. Next, the processing proceeds to step S910, and the print data in the job spool area 502 on the SD card is cleared when the transfer of print data to the NAND Flash ROM completes. This corresponds to moving the data of the job spool area 502 on the SD card to the NAND Flash ROM.

As explained above, according to the embodiment, in the reprint mode, when the printing of a secure print job finishes, the data of that print job is saved onto a storage device that is implemented on the circuit board. Because of this, the security risk of saving print data for reprinting is lowered. In this way, the reprint function can be provided to the user for secure print, and the convenience of the user can thereby be improved.

In this way, the location in which print data is saved for reprint is switched for normal print data and for print data for which security is emphasized. Due to this, the security risk of implementing a reprint function can be lowered, and the reprint function can be provided for jobs such as secure print jobs for which security is emphasized.

Note, a time period for which the data of a secure print job is saved may be set, and when that time period elapses, the data of the job spool area in the NAND Flash ROM may be automatically deleted. In this case, the deletion processing is executed irrespective of such things as the printing processing and the processing for receiving data.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-018633, filed Jan. 31, 2012, which is hereby incorporated by reference herein in its entirety.

What is claimed is:

1. A printing apparatus, to which a first memory removably connects, the printing apparatus comprising:
a receiving unit configured to receive print data;
a controller configured to store in the first memory the print data received by the receiving unit; and
a printer configured to print the print data stored in the first memory;
wherein the controller stores the print data stored in the first memory in a second memory and, after the printer has printed the print data stored in the first memory, deletes the print data stored in the first memory, in a case where the print data received by the receiving unit is job data for which authentication is necessary before printing,
and wherein the controller retains the print data stored in the first memory even after the printing, in a case where the print data received by the receiving unit is not job data for which authentication is necessary before printing.

2. The printing apparatus according to claim 1, wherein the first memory is an SD card or a hard disk.

3. The printing apparatus according to claim 1, wherein the second memory is a non-removable memory.

4. The printing apparatus according to claim 1, further comprising a management unit configured to manage attributes of the print data stored in the first memory,
wherein the attributes managed by the management unit at least include a print job name and a print job save date and time.

5. The printing apparatus according to claim 4, wherein the management unit sets a time period for which to save the print data, the printing apparatus further comprising a deletion unit configured to delete the print data from the second memory when the time period elapses.

6. A method for controlling a printing apparatus, to which a first memory removably connects, the method comprising:
a receiving step of receiving print data;
a step of storing in the first memory the received print data;
a printing step of printing the print data stored in the first memory;
a step of storing the print data stored in the first memory in a second memory and, after the print data stored in the first memory is printed in the printing step, deleting the print memory stored in the first memory, in a case where the print data received in the receiving step is job data for which authentication is necessary before printing, and
a step of retaining the print data stored in the first memory even after the printing, in a case where the print data received by the receiving unit is not job data for which authentication is necessary before printing.
